(19) United States
(12) Patent Application Publication
(10) Pub. No.: US 2022/0111475 A1
(43) Pub. Date: Apr. 14, 2022

(54) DELIVERY APPARATUS FOR MOVING WORKPIECES

(71) Applicant: MIDACO CORPORATION, ELK GROVE VILLAGE, IL (US)

(72) Inventors: Michael P. Cayley, JR., Schaumburg, IL (US); Vincent P. Storelli, Chicago, IL (US)

(73) Assignee: MIDACO CORPORATION, ELK GROVE VILLAGE, IL (US)

(21) Appl. No.: 17/067,090

(22) Filed: Oct. 9, 2020

(51) Int. Cl. B23Q 5/28; B65G 47/90

(52) U.S. Cl. CPC B23Q 5/28; B65G 2201/0267; B65G 47/901

(57) ABSTRACT

A method and apparatus for delivering workpieces to and from a machine table. This invention also relates to an apparatus for receiving at the machine table workpieces which are delivered to and retrieved by the delivery system. Carts move with respect to a surface, such as a floor surface. The carts move and deliver pallets to a loading station that uses a loading arm to deliver pallets with workpieces to and from a machine table.

### BACKGROUND OF THE INVENTION

### Field of the Invention

This invention relates to a system and method for delivering and retrieving workpieces to and from a machine table, such as a CNC machine or a 5-axis machine table, and to a system and method for receiving the workpieces at the machine table.

### Discussion of Related Art

Delivery systems are known for moving workpieces from a staging or supply area or location to a machine table, such as a CNC machine or a 5-axis machine. Many conventional delivery systems have a loading arm or similar element that rotates to pick up pallets holding workpieces. Other conventional delivery systems rotate the loading arm with respect to a table to pick up workpieces.

Cayley, Sr. et al., U.S. Pat. No. 9,950,867, and Cayley, Sr. et al., U.S. Pat. No. 10,486,278, teach known methods and apparatuses for delivering and retrieving workpieces to and from a machine table.

Many conventional delivery systems have a relatively large or substantial footprint and thus requires a significant amount of manufacturing floor space, which is relatively expensive. There is an apparent need for a delivery system that has a loading arm that moves, preferably but not necessarily in a linear direction to pick up workpieces from a mobile cart.

### SUMMARY OF THE INVENTION

The delivery system of this invention provides access to workpieces or other materials to be modified without a requirement for a loading arm to rotate or pivot to pick up workpieces. The delivery system of this invention uses a train formed by one or more carts which can be moved into a position in which a programmable and/or displaceable loading arm moves, preferably within two dimensions, to pick up, move, deliver and/or retrieve pallets to and from a machine table of a CNC machine or another suitable machine. Each pallet has an attached workpiece and each pallet is releasably attached to one of the carts. The delivery system of this invention also uses movers to move the carts and/or the train to a loading station for the loading arm, for example, without rotating or pivoting to pick up the pallets with loaded workpieces and to move the workpieces to a machine table, which results in significant manufacturing and use cost reductions.

The loading arm of this invention accesses and delivers pallets, with attached workpieces, to the machine table. A receiver of this invention can be mounted at an existing machine table, such as a CNC machine or a 5-axis machine table, or can be mounted at a new machine table. The receiver can be located at the machine table and can accept pallets with attached workpieces, and the pallets can be delivered to the machine table, by the delivery system of this invention. The machine table can then machine or otherwise work the workpieces locked with respect to the receiver. Then, the loading arm can return the machined or worked workpieces on the pallet for the delivery system to retrieve, move and store the worked workpieces at a storage facility.

### BRIEF DESCRIPTION OF THE DRAWINGS

The above and other features and objects of this invention are better understood from the following detailed description taken in view of the drawings, wherein:

FIG. 1 is a perspective view of an apparatus and a method for using carts and pallets to deliver and retrieve workpieces, according to one embodiment of this invention;

FIG. 2 is a perspective view of an apparatus and a method for delivering and retrieving workpieces to and from a work envelope of a machine, according to one embodiment of this invention;

FIG. 3 is a perspective view of an apparatus and a method for delivering and retrieving workpieces to and from a work envelope of a machine, according to one embodiment of this invention;

FIG. 4 is a perspective view of a loading station of an apparatus and a method for delivering and retrieving workpieces to and from a work envelope of a machine, according to another embodiment of this invention; and

FIG. 5 is a partial perspective view of a loading arm of an apparatus and a method for delivering and retrieving workpieces to and from a work envelope of a machine, according to one embodiment of this invention.

### DETAILED DESCRIPTION OF THE INVENTION

Cayley, Sr. et al., U.S. Pat. No. 9,950,867, and Cayley, Sr. et al., U.S. Pat. No. 10,486,278, the entire disclosures of which are incorporated into this specification by reference thereto, describe methods and apparatuses for delivering and retrieving workpieces to and from a machine table, and some elements, systems and/or process steps of those U.S. patents can be used in combination with, in addition to and/or in place of some of the elements of this invention as described in this specification and/or as shown in the drawings of this invention.

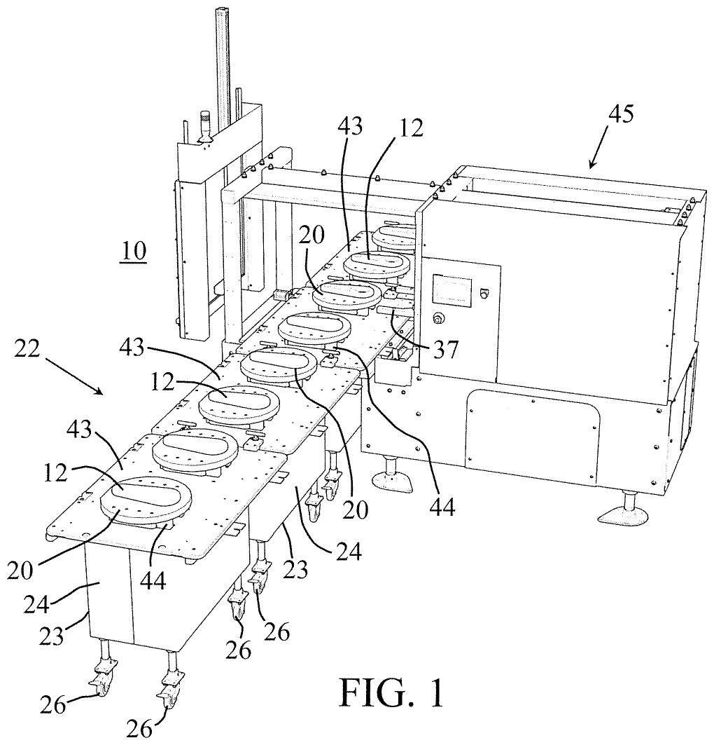

FIG. 1 shows a perspective view of a system and/or an apparatus, according to some embodiments of this invention, which can be part of a delivery system, for example, to use pallets 20 to deliver workpieces 12 to machine table 10. FIG. 1 shows train 22 comprising or including 4 carts 23 each having 2 pallets 20 connected, attached and/or otherwise detachably secured directly to and/or indirectly with respect to cart 23. In other embodiments of this invention, train 22 can have more or less than 4 carts 23, and top 43 of cart 23 can have more or less than 2 mounted pallets 20, depending upon the total number of workpieces 12 desired.

FIG. 1 shows cart 23 comprising body 24 and rollers 26 connected, attached and/or otherwise secured with respect to body 24. In other embodiments of this invention, cart 23 can have slides, tracks, rails and/or any other suitable element and/or system that allows cart 23 to move with respect to loading arm 37, such as shown in FIGS. 1-3. In some embodiments of this invention, a mover, such as a moving apparatus or system, moves or transfers train 22 and/or cart 23 in a downline direction or an upline direction, so that an active pallet 20 is positioned at or near loading arm 37 of loading station 45. The mover can be an apparatus, a system, elements and/or any other parts or methods that allow or result in moving cart 23 with respect to loading arm 37, such as in the downline direction or the upline direction. In some embodiments of this invention, loading arm 37 moves and/or otherwise operates to engage with an active pallet 20, and after the active pallet 20 is delivered to machine table 10 and is moved back to cart 23, the mover moves train 22 and/or cart 23 to engage and/or otherwise work on the next inline pallet 20 or another suitable active pallet 20.

In some embodiments of this invention, for example as shown in FIGS. 1-3, cart 23 has 4 rollers 26 attached, secured and/or otherwise fixed in position with respect to body 24 of cart 23. In other embodiments of this invention, more or less than 4 rollers 26 can be used to move cart 23, such as with respect to loading arm 37 of loading station 45. In addition to or in place of rollers 26, any other suitable slide, track, rail and/or other structural element and/or system can be used to allow cart 23 to move with respect to loading arm 37.

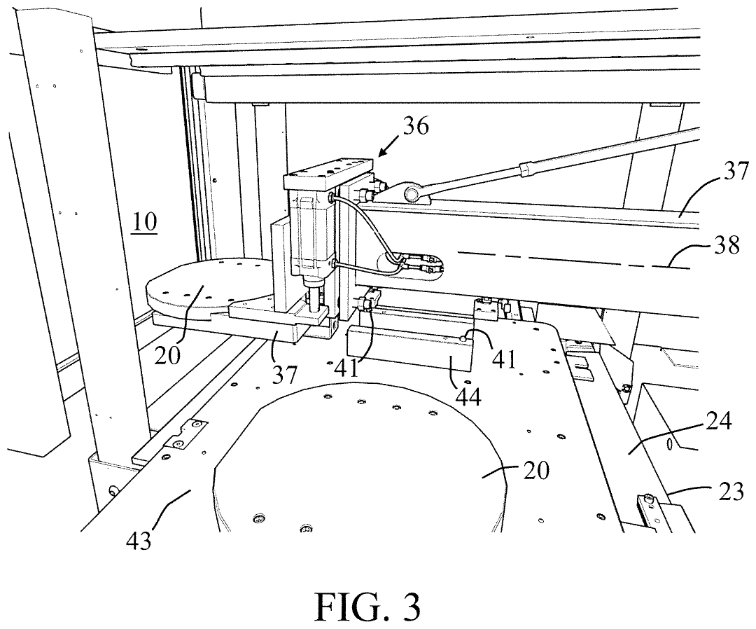

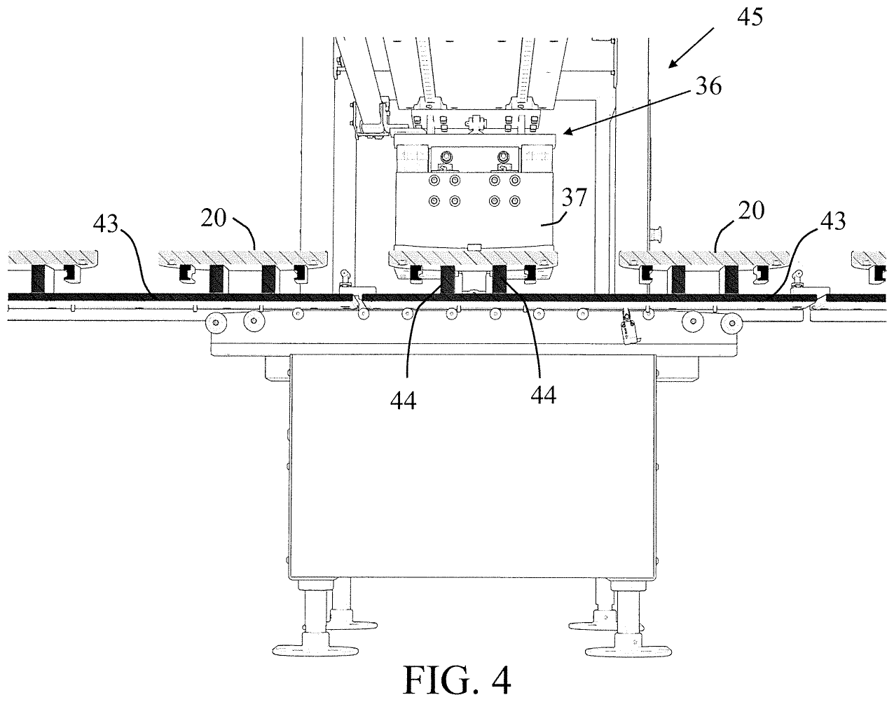

According to some embodiments of this invention, such as shown in FIGS. 1-4, top 43 can be secured, attached and/or otherwise fixed in position with respect to body 24, for example, in a permanently fixed position or in a removably fixed position. In some embodiments of this invention, top 43 comprises one or more struts 44 and/or other suitable structural elements, each that allows pallet 20 to be positioned on and supported by each strut 44. In some embodiments of this invention, strut 44 and/or pallet 20 comprise locating pins 41, such as shown in FIG. 3, that allow each pallet 20 to be positioned and/or located in a defined position that temporarily holds, secures and/or otherwise fixes the position of pallet 20 with respect to top 43 and/or cart 23.

The elements, the apparatuses and/or the systems of this invention can have any suitable layout, size, shape and/or dimensions that are suitable for any particular use and/or desired result of this invention. In some embodiments of this invention, machine table 10, such as shown in FIG. 1, is a machine table, such as a CNC (computer numerical control) machine or a 5-axis machine table known to those skilled in the art of manufacturing. In some embodiments of this invention, pallet 20 is delivered onto a receiver secured, fixed and/or otherwise mounted onto a table surface of machine table 10 and persons skilled in the art of manufacturing know a suitable term to be a “work envelope” of the CNC machine or other machine to which pallet 20 is delivered and mated. Machine table 10 can be any other suitable device, apparatus and/or system that accepts, works, modifies and/or returns one or more workpieces 12.

In some embodiments of this invention, a method for delivering and retrieving workpieces 12, such as to and from machine table 10, includes attaching, connecting and/or otherwise securing each workpiece 12 with respect to a corresponding one of pallets 20, such as shown in FIG. 1. Any suitable apparatus or device can be used to secure workpiece 12 with respect to pallet 20, which are known to those skilled in the art of manufacturing. In some embodiments of this invention, workpiece 12 is removably secured and/or attached with respect to pallet 20, directly and/or indirectly.

In some embodiments of this invention, pallet 20 is detachably mounted or removably mounted, directly, indirectly and/or otherwise with respect to top 43 of cart 23. According to some embodiments of this invention, each of a plurality of pallets 20 moves with respect to loading station 45. In some embodiments, train 22 has multiple carts 23 and as shown in FIG. 1, forms a relatively straight line formation but in other embodiments of this invention train 22 has multiple carts 23 that forms a non-linear formation or configuration. Train 22 can be formed along a rail, a track, an elongated member and/or any other suitable device or apparatus that allows pallet 20 to move with respect to loading arm 37 of loading station 45.

As shown in FIG. 1, moving one cart 23 contacts or engages with and moves at least one other cart 23 or adjacent cart 23. In some embodiments of this invention, about 4-25 adjacent carts 23 are positioned in one train 22 and each cart 23 moves train 22 along or with respect to the corresponding loading arm 37.

FIG. 1 shows one workpiece 12 mounted or otherwise secured with respect to one pallet 20. In other embodiments of this invention, it is possible to mount or otherwise secure two or more workpieces 12 with respect to one pallet 20.

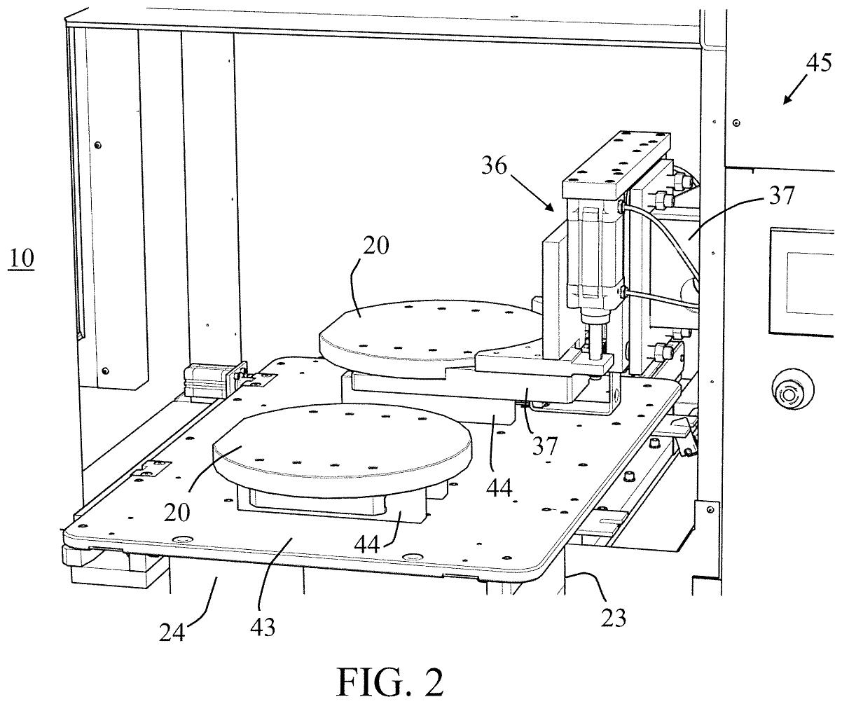

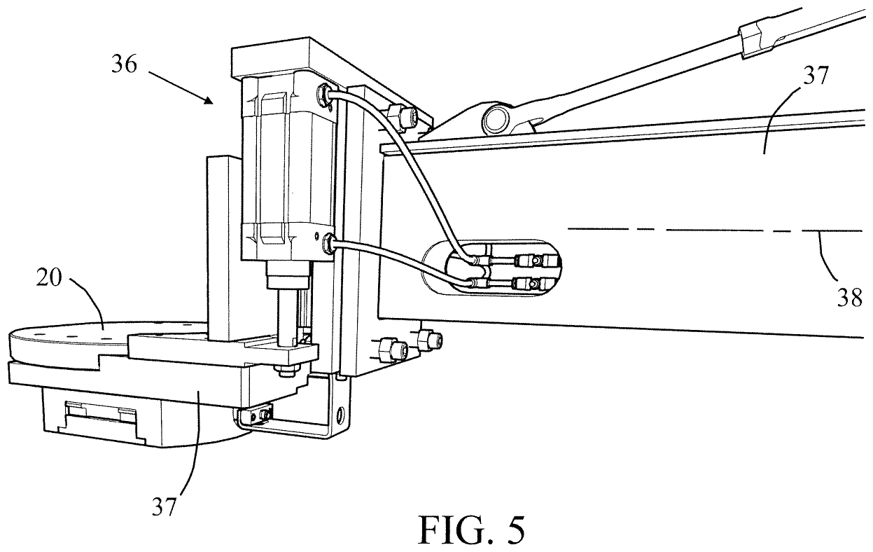

FIGS. 1-5 each shows pallet 20 being an active pallet 20 when positioned at loading station 45. In some embodiments of this invention, loading arm 37 moves along a travel path to pick up or lift pallet 20 away from top 43, such as at loading station 45, and delivers pallet 20 with the mounted or secured workpiece 12 from loading station 45 to machine table 10. According to some embodiments of this invention, loading arm 37 moves along a linear travel path to pick up or lift pallet 20, sometimes in a fashion in which loading arm 37 does not move from side-to-side, such as along a width of loading arm 37. The linear travel path, particularly of loading arm 37 can reduce costs, because there is no need or requirement to move loading arm 37 in a direction perpendicular to or in a direction at any other angle or even in a rotatable manner. As shown in FIGS. 2-5, lifter 36 raises and/or lowers pallet 20 with respect to top 43 of cart 23 and/or any other suitable element and/or part of cart 23. Any suitable hydraulic, electrical, magnetic and/or other lifting device can be used to accomplish raising and/or lowering pallet 20 with respect to top 43 of cart 23 and/or any other suitable element and/or part of cart 23. As shown in FIGS. 1-4, supports, such as struts 44 and/or any other suitable support structure, can be positioned to engage and lift and/or raise pallet 20 with respect to top 43 of cart 23 and/or any other suitable element and/or part of cart 23.

Costs of building and operating loading arm 37 can be reduced, for example, by limiting movement of loading arm 37 in only two dimensions. In some embodiments according to this invention, loading arm 37 moves or operates in only two dimensions by loading arm 37 moving between loading station 45 and machine table 10, only in a planar air space or void having a length, a width and a depth forming boundaries of the planar air space. In some embodiments of this invention, such as shown in FIGS. 1-4, loading arm 37 moves forward and backward, such as along longitudinal axis 38 of loading arm 37. In some embodiments of this invention, loading arm 37 is movably mounted with respect to a shaft, for example, a rotating screw shaft and/or any other suitable moving shaft or other device. In some embodiments of this invention, the planar space is defined by a length equal to the longitudinal movement of loading arm 37 with respect to loading station 45, such as along longitudinal axis 38, a depth equal to the lifting and lowering movement of lifter 36 such as in a vertical direction, and a width equal to a width dimension of loading arm 37.

In some embodiments, machine table 10 receives or otherwise accepts pallet 20 or an active pallet 20 and then moves and/or performs work on workpiece 12, and then machine table 10 returns pallet 20 or active pallet 20 with the attached and already worked or modified workpiece 12. In some embodiments of this invention, such as shown in FIGS. 1-5, a delivery system moves an active pallet 20 from loading station 45 to machine table 10, preferably but not necessarily along a linear travel path which may or may not be generally parallel to longitudinal axis 38. The delivery system of this invention, in some embodiments, positions active pallet 20 and then loading arm 37 moves to lift and/or otherwise remove active pallet 20 of pallets 20 so that active pallet 20 moves away from cart 23, which cart 23 remains movably attached and/or fixedly mounted with respect to loading station 45, and delivers and receives active pallet 20.

According to some embodiments of this invention, cart 23 remains movably attached or otherwise connected to train 22, so that active pallet 20 can be picked up and easily moved away from top 43 and/or any other part or element of cart 23 and towards machine table 10, particularly when loading arm 37 or another suitable displacement device lifts or otherwise picks up and moves active pallet 20 away from loading station 45. In some embodiments of this invention, each cart 23 is able to move with respect to loading arm 37 and/or loading station 45 and not get out of line or derail from train 22.

FIG. 1 shows one embodiment of cart 23 movably and/or controllably mounted with respect to loading arm 37 and/or loading station 45. As shown in FIG. 1, rollers 26 are secured or otherwise removably attached to each cart 23. As shown in FIG. 1, roller 26 contacts a surface, such as a floor surface, to allow each cart 23 and thus train 22 to move or be guided in motion with respect to loading arm 37 and/or loading station 45, particularly without each cart 23 being moved, detached, derailed and/or otherwise removed from train 22. Each roller 26 can be used to significantly reduce frictional forces caused by or resulting from cart 23 moving with respect to loading arm 37 and/or loading station 45. Each roller 26 can be used to reduce forces necessary to move cart 23. Many other different mechanical, electrical and/or magnetic devices can be used to accomplish the same result of moving each cart 23.

In some embodiments according to this invention, a moving device or a mover engages and moves at least one cart 23 with respect to loading arm 37 and movement of cart 23 engages and moves, directly or indirectly, other carts 23 of train 22 into or at a position located at or near loading station 45, so that loading arm 37 can reach and act on active pallet 20 and move it to machine table 10. In some embodiments of this invention, displacement or other movement of cart 23 causes movement of another cart 23 that then moves an adjacent cart 23, which moves another adjacent cart 23 of train 22, and so on, so that loading arm 37 can access and move multiple or several different workpieces 12 to machine table 10.

FIG. 1 shows about 4 different carts 23 being part of and/or mounted or positioned within train 22. In other embodiments of this invention, it is possible for train 22 to comprise more or less than 4 carts 23 and still accomplish the result of moving pallet 20 and the corresponding workpiece 12 with respect to loading arm 37 and/or loading station 45. It is possible to use any suitable number and/or positioning of the mover device or the mover moving carts 23 and train 22, depending upon the number of carts 23 and/or the layout or configuration that train 22 follows.

In some embodiments of this invention, loading arm 37 and/or loading station 45 includes a lift or a lift station for raising, lowering and/or otherwise moving pallet 20 or active pallet 20 between loading station 45 and machine table 10. In some embodiments of this invention, the lift or the lift station for raising and lowering or otherwise moving pallet 20 or active pallet 20 comprises any suitable arm, lift, lift device, elevator and/or any other suitable apparatus, device and/or method that raises, lowers and/or otherwise moves one or more pallets 20 or active pallets 20 from loading station 45 to machine table 10.

In different embodiments according to this invention, including the embodiment shown in FIG. 1, multiple trains 22 of carts 23 can be used to set up or preload many different workpieces 12 that can be delivered to and from machine table 10, which can significantly reduce the cost of manufacturing and using the delivery system according to this invention, particularly the movements of loading arm 37 or another similar device.

Loading arm 37 and/or other elements or components of the delivery system, according to some embodiments of this invention, are used to move, transfer, transport and/or otherwise locate or position pallet 20 or active pallet 20, each which has a mounted workpiece 12, preferably but not necessarily attached to pallet 20, to machine table 10. In some embodiments, machine table 10 can be an existing machine table or can be a new machine table. In some embodiments according to this invention, a receiver is installed at and/or used with any suitable existing machine table 10 or a new machine table 10. The receiver according to this invention can receive workpieces 12 which are delivered to and retrieved by an actuator of the delivery system according to this invention. Any receiver having features according to this invention can be used with an existing machine table 10 or a new machine table 10.

In some embodiments according to this invention, a method for receiving workpieces 12 at machine table 10, which are delivered to and retrieved by the delivery system includes movably mounting loading arm 37 with respect to machine table 10. In some embodiments of this invention, a sequence of movements, controlled or not controlled, of loading arm 37 can be used to move one active pallet 20 from cart 23, unload the active pallet 20 at machine table 10, and then return to restart the method or process by moving the next pallet 20 which moves and becomes active pallet 20, and the method or process steps can repeat.

FIG. 1 shows an initial step or method in which loading arm 37 approaches an active pallet 20 which is moved into position and is ready to be lifted away from cart 23, and loading arm 37 begins the method cycle. As shown in FIG. 1, cart 23 is moved until active pallet 20 is in position for loading arm 37 to begin lifting active pallet 20 with mounted workpiece 12 away from top 43 of cart 23.

FIG. 2 shows a later or further step or method in which loading arm 37 detachably engages with and forms contact with active pallet 20 and lifts active pallet 20 away from top 43 of cart 23. As shown in FIG. 2, cart 23 is held in position or stopped in place so that loading arm 37 can move and engage with active pallet 20.

FIG. 3 shows a yet later or further step or method in which loading arm 37 continues to move in a direction towards machine table 10. Loading arm 37 delivers active pallet 20 with the corresponding workpiece 12 to machine table 10 and drops or unloads pallet 20 with workpiece 12 so that machine table 10 can perform work on workpiece 12. After workpiece 12 is worked, processed and/or otherwise machined at machine table 10, loading arm 37 removes or moves active pallet 20 with the worked or processed workpiece 12 and drops, sets and/or otherwise positions active pallet 20 on or at cart 23. Loading arm 37 then returns to its initial position to restart the cycle or process with the next pallet 20 moved in a downstream direction by cart 23 until the next pallet 20 becomes active pallet 20 to restart the cycle or process.

In some embodiments according to this invention, the moving device or the mover that moves cart 23 can be any suitable system and/or apparatus that moves cart 23 and thus train 22 in a controlled fashion. In some embodiments of this invention, a computer, an electronic controller and/or associated software program is used with a computer hard drive to automatically control movement of cart 23 and/or train 22, depending upon the particular number of pallets 20 and/or workpieces 12 loaded on each cart 23.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

What is claimed is:

1. A method for delivering workpieces to and from a machine table, the method including the steps of:
securing each of the workpieces with respect to a corresponding one of a plurality of pallets;
removably mounting each of the pallets to a corresponding one of a plurality of carts;
moving the carts with respect to a loading station;
stopping one of the carts at the loading station; and
moving an active pallet of the pallets from the loading station to the machine table.

2. The method according to claim 1, wherein a loading arm moves the active pallet from the loading station to the machine table.

3. The method according to claim 1, wherein a mover engages and moves at least one of the carts with respect to the loading station.

4. The method according to claim 3, wherein moving the mover contacts and moves each of the carts in a downline direction towards the loading station.

5. The method according to claim 1, wherein a pin attached with respect to a top of each cart is used to locate and removably mount a corresponding one of the pallets to the top.

6. The method according to claim 1, wherein a programmable controller cooperates with a mover to move each of the carts along a specified path.

7. The method according to claim 1, wherein a loading arm lifts the active pallet away from a top of the cart.

8. The method according to claim 7, wherein each of the pallets contacts and is supported by a strut attached with respect to the top of the cart.

9. The method according to claim 1, wherein each active pallet is moved from the loading station to the machine table along a linear path.

10. The method according to claim 1, further comprising a loading arm engaging and raising the active pallet, moving the active pallet along a linear path, and delivering the active pallet to the machine table.

11. A method for delivering workpieces to and from a machine table, the method including the steps of:
attaching the workpieces with respect to a plurality of pallets;
mounting each of the pallets to one of a plurality of carts;
moving the carts with respect to a loading station;
stopping one of the carts at the loading station; and
moving one of the pallets from the loading station to the machine table.

12. The method according to claim 11, wherein a loading arm moves one of the pallets from the loading station to the machine table.

13. The method according to claim 11, wherein a mover engages and moves at least one of the carts with respect to the loading station.

14. The method according to claim 13, wherein moving the mover contacts and moves each of the carts towards the loading station.

15. The method according to claim 11, wherein a pin attached with respect to a top of each cart is used to locate and removably mount a corresponding one of the pallets.

16. An apparatus for delivering and retrieving workpieces to and from a machine table, the apparatus comprising:
a plurality of pallets, each said workpiece releasably secured with respect to a corresponding one of the pallets, a plurality of carts each movably mounted with respect to a loading station, a mover for moving the carts, a loading arm movably mounted to travel along a path between the loading station and the machine table, and the loading arm lifting one of the pallets and delivering the one of the pallets to the machine table.

17. The apparatus according to claim 16, wherein the loading arm moves in only two dimensions within a planar space between the loading station and the machine table.

18. The apparatus according to claim 16, wherein the carts form a train of carts.

19. The apparatus according to claim 16, wherein the carts each has at least one roller contacting a surface.

20. The apparatus according to claim 16, wherein each of the carts has a strut attached with respect to the cart and releasably supporting the one of the pallets.
